(19) United States
(12) Patent Application Publication
(10) Pub. No.: US 2003/0083816 A1
(43) Pub. Date: May 1, 2003

(54) Portable terminal device

(76) Inventors: Yoshitaka Imakado, Hitachinaka (JP); Yoshiaki Umehara, Hitachiota (JP); Fumiharu Nakahara, Hitachinaka (JP); Naoki Tsuji, Hitachinaka (JP)

Correspondence Address: MCDERMOTT WILL & EMERY, 600 13TH STREET, N.W., WASHINGTON, DC, 20005-3096, US

(21) Appl. No.: 10/283,344

(22) Filed: Oct. 30, 2002

(30) Foreign Application Priority Data
Oct. 31, 2001 (JP) 2001-333676

(51) Int. Cl. G01C 21/36; G01S 1/00

(52) U.S. Cl. 701/213; 342/357.06

(57) ABSTRACT

A portable terminal device including GPS correctly detects a position thereof by preventing an error due to a state of an environment thereof. In a portable telephone including a GPS receiver capable of receiving a GPS signal according to GPS assist information sent from a reference GPS receiver server continuously receiving GPS signals from GPS satellites, a result of acquisition of each GPS signal received by the telephone using the GPS assist information and the like is evaluated to produce GPS information to be reported to the server.

### BACKGROUND OF THE INVENTION

The present invention relates to a portable terminal device using position information of a global positioning system (GPS) and the like.

As described in JP-A-11-513787 (WO 97/14049), a portable terminal device on which the GPS is mounted operates as follows. Assist information to acquire a signal from a GPS satellite is supplied to the terminal device. According to a signal received from the terminal device in response to the assist information, a server (base station) as a reference GPS receiver executes processing to detect a position of the terminal device. This minimizes size of the terminal device and reduces power consumed by the terminal device.

In the global positioning system, a plurality of satellites are placed to surround the earth. A receiver on the earth receives signals from the satellites. According to the difference between the values of arrival time of the signals, distances between the receiver and the satellites are measured. Through a geometric calculation, a position of the receiver on the earth is obtained. In the technique, the server continuously observes the GPS satellites and transmits GPS assist information from the base station to the terminal device at timing synchronized with synchronization timing of each signal received from the satellites. The GPS assist information includes the number of GPS satellites from which the terminal device can receive signals, a range of synchronization timing of each GPS satellite for the terminal device to receive signals therefrom, and elevation (an elevation angle of each GPS satellite viewed from the server). The terminal device including a GPS receiver makes a search using the GPS assist information for signals received from the GPS satellites. The terminal device reports the acquired GPS assist information again via the base station to the server. The server then sends a calculation result of position detection to the terminal device. The terminal resultantly device acquires the position thereof.

### SUMMARY OF THE INVENTION

At each position where the user desires the position detecting service, it is not always possible to observe all the GPS satellite disposed for the service. In the neighborhood of high-rise buildings, there appear in addition to direct waves many multipath reflected waves. This causes a considerable error in the position detection. In the prior art, the portable telephone including a GPS receiver regards as a direct wave a wave first arrived at the receiver, regardless of whether the acquired GPS signal is a direct wave or a reflected wave caused by the multipath. The portable telephone then reports all results of the signal acquisition to the server. The server executes processing to detect the position using the obtained GPS information. Therefore, if the acquisition results reported from the portable telephone include a large number of acquisition results associated with the reflected waves, the obtained detection value includes a large number of errors. Additionally, it is impossible that all signals of direct waves are completely satisfactory for the processing. Even the acquisition results associated with the direct-wave signals include errors if field intensity is low. This consequently becomes a factor of errors in the obtained position detection value.

The portable telephone including a GPS receiver operates assuming that the telephone receives GPS assist information sent from the base station at timing synchronized with synchronization timing of the GPS signal. Although there exists propagation delay before the assist information from the base station arrives at the telephone, the assist information beforehand includes a quantity of propagation delay. Therefore, the terminal device executes synchronous processing by predicting synchronization timing of a signal from each GPS station and hence can acquire GPS signals from the GPS satellites at a high speed. Moreover, the system is configured such that once the synchronization is established, the synchronized state is not easily changed. Therefore, the GPS signals can be received with high sensitivity by conducting integration for a long period of time.

However, to increase a cover ratio of traffic of the portable telephone, the base station to transmit the GPS assist information is connected to an optical repeater station via an optical cable or the like. The GPS assist information is completely the same as that transmitted from a donor base station. Therefore, when the terminal receives the GPS assist information from the optical repeater station, the information is shifted by influence of the delay through the optical cable and hence it is impossible in some case for the terminal to acquire the GPS signals. Also when the information is received from an unexpected, remote base station according to geographical features and/or conditions of locations, unpredicted propagation delay may take place to exert adverse influence upon the position detection depending on cases.

The present invention aims at solving the problem on the side of the terminal device. It is therefore an object of the present invention to provide a portable terminal device including a global positioning system capable of preventing occurrence of errors by environmental states or situations to correctly detect a position of the terminal device.

To solve the problem according to the present invention, there is provided a portable terminal device including a global positioning system capable of receiving position measurement assist information. The information includes information transmitted from a base station including a server to receive a signal from a satellite, the information being used to establish synchronization with the signal from the terminal and includes elevation information corresponding to an elevation angle of the satellite viewed from the base station. The terminal device is also capable of receiving a signal from the satellite. The terminal device includes a processor section to process the signal received from the satellite, a communicator section to conduct communication with the base station, and a control section to control the processor and communicator sections. The communicator section conducts a control operation for information to the server according to an acquisition result of the satellite signal received by the terminal device. Using the acquisition result of the satellite signal received by the terminal device, the control section also determines timing of synchronization for subsequent signals from the satellite.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram to explain constituent components of a first embodiment of a position measuring system using a GPS satellite according to the present invention.

FIG. 2 is a diagram to explain reflection of waves in a second embodiment of the present invention.

FIG. 3 is a flowchart of the second embodiment of the present invention.

FIG. 4 is a flowchart of a third embodiment of the present invention.

FIG. 5 is a diagram to explain constituent components of a fourth embodiment of a GPS position measuring system including an optical repeater station according to the present invention.

FIG. 6 is a diagram to explain a remote base station in the fourth embodiment of the present invention.

FIG. 7 is a graph to explain a search window of a standard system in the first and fourth embodiments of the present invention.

FIG. 8 is a graph to explain a search window when an optical repeater station is disposed in the fourth embodiment of the present invention.

FIG. 9 is a graph to explain a search window for a remote base station in the fourth embodiment of the present invention.

FIG. 10 is a flowchart of the fourth embodiment of the present invention.

FIG. 11 is a flowchart of a fifth embodiment of the present invention.

FIG. 12 is a flowchart of a sixth embodiment of the present invention.

FIG. 13 is a flowchart of a seventh embodiment of the present invention.

FIG. 14 is a diagram showing an example of constitution of a portable telephone in the first embodiment of the present invention.

### DESCRIPTION OF THE EMBODIMENTS

Description will now be given of an embodiment of the present invention by referring to diagrams 1 to 14.

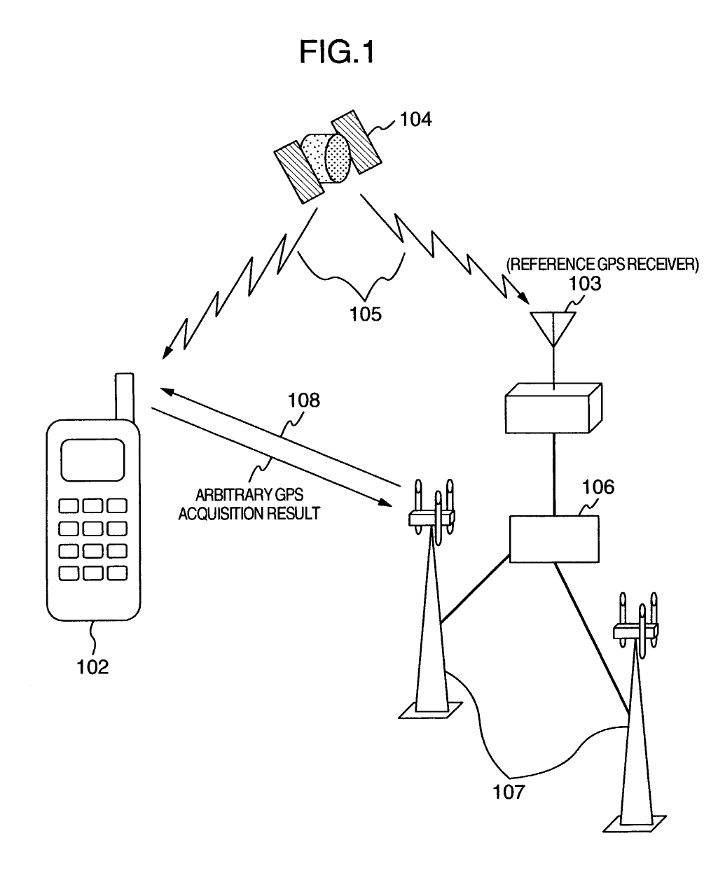

The embodiment is an example of application of the present invention to a code division multiple access (CDMA) method. In the CDMA method, a signal sent from a high-precision clock system of a GPS satellite is received and is used as a reference of time. In the following description of embodiments, the system includes at least four GPS satellites as an illustration. A base station includes a server, namely, a reference GPS receiver to continuously receive a GPS signal from a GPS satellite. The base station transmits, via an exchange, GPS assist information (position measurement assist information) at timing synchronized with synchronization timing of the GPS signal. The assist information includes information to synchronize with the signal from each GPS satellite and elevation information corresponding to an elevation angle of the GPS satellite viewed from the base station. The elevation is an elevation angle of the satellite. FIGS. 1, 2, 5, and 6 representatively show one GPS satellite or two GPS satellites.

The first embodiment of the present invention will be described by referring to FIGS. 1, 7, and 14. In this embodiment, a portable telephone including a GPS receiver 120 (to be referred to as a portable telephone hereinbelow) is used as the portable terminal device.

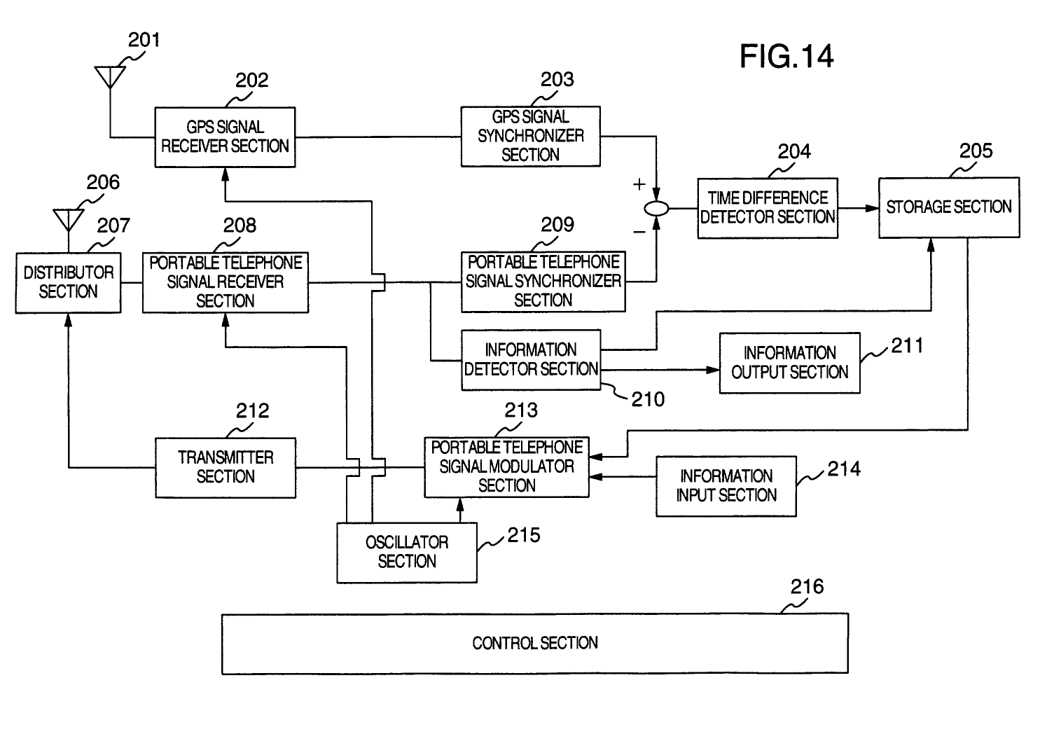

FIG. 14 shows a construction of the portable telephone 102. The telephone 102 includes a storage section 205, an information output section 211, an information input section 214, an oscillator section 215, and a control section 216. The telephone 102 includes constituent components to process GPS signals such as a GPS antenna 201, a GPS signal receiver section 202, a GPS signal synchronizer section 203, and a time difference detector section 204. The telephone 102 also includes constituent components of a portable telephone such as a portable telephone antenna 206, a distributor section 207 for transmission and reception, a portable telephone signal receiver section 208, a portable telephone signal synchronizer section 209, an information detector section 210, a portable telephone signal transmitter section 212, and a portable telephone signal modulator section 213.

A GPS signal received by the antenna 201 and a signal from the oscillator 215 are supplied to the GPS signal receiver 202 to detect these signals through a heterodyning operation. The detected signals are fed to the GPS signal synchronizer 203. The information output section 211 includes a liquid-crystal display, a speaker, and a vibrator to notify a call received by the telephone 102. The input section 214 includes a key switch unit, a microphone, and a small-sized video camera. FIG. 14 does not show relationships between the controller 216 and the other components. However, the controller 216 is connected to the components other than the antenna 201 and 206. Having received a signal from each of the components, the controller 216 controls operation of the component according to the received signal. The oscillator 215 supplies each of the GPS signal receiver section 202, the telephone signal receiver section 208, and the telephone signal modulator section 213 with a periodic signal of a frequency required by the section. The oscillator 215 supplies each of the GPS signal receiver section 202 and the telephone signal receiver section 208 with a periodic signal for heterodyne detection in the section. When a GPS signal is received, the GPS signal receiver section 202 outputs the GPS signal under control of the controller 216. When a portable telephone signal is received, the telephone signal receiver section 208 outputs the telephone signal.

Description will now be given of operation of the telephone 102 as a portable telephone, specifically, signal processing, functions, and an operation method of the portable telephone 102. A high-frequency received by the antenna 206 is fed via the distributor 207 to the telephone signal receiver 208 and is then demodulated by the receiver 208 into a portable telephone signal. Having received the signal from the receiver 208, the information detector 210 obtains therefrom information necessary to communicate information including an audio signal, image information, and/or character information. The detector 210 then outputs or stores at least one of the information items to or in the information output section 211 or the storage 205 under control of the controller 216. The information output section 211 is specifically an audio output unit such as a telephone receiver or a speaker for an audio signal and a display such as a liquid-crystal display for image or character information. The information input section 214 is used to input information necessary to communicate information including an audio signal, image information, and/or character information. The information input section 214 is specifically an audio input unit such as a telephone transmitter or a microphone for an audio signal, a video camera for image information, and an input key unit (including a touch panel) for character information. The information input section 214 then outputs a signal. The signal is supplied to the telephone signal modulator 213, and the modulated signal is fed to the transmitter section 212. The transmitter 212 converts the signal into a high-frequency signal and transmits the signal via the distributor 207 and the antenna 206.

An instruction to start position measurement is inputted by a key switch of the information input section 214. On receiving the instruction, the controller 216 issues a position measurement start request signal. The modulator 213 modulates the request signal. The telephone signal transmitter 212 converts and amplifies the modulated signal into a signal for radio transmission. The antenna 206 transmits the radio signal to a reference OPS receiver server 103 nearest to the portable telephone 102. Before the radio signal transmission, the portable telephone 102 establishes synchronization with the nearest base station 107 to set a communicable state, for example, by confirming respective identifiers (ID). In the communicable state with respect to the base station 107, synchronization is established for a GPS signal, and time difference between a reference signal from the base station 107 and a reference signal in the GPS signal is detected by the time difference detector 204. This operation is called synchronization acquisition in the position measurement. After the time difference between the reference signals is stored in the storage 205 and the synchronization acquisition has been successfully completed for specified GPS satellites, the time difference is transmitted, in response to an instruction from the controller 216, via the base station 107 to the server 103.

In the description, “acquisition” means that the telephone obtains synchronization timing for the signal received from the GPS satellite and is hence enters a state ready for processing. Moreover, “acquisition result” means propagation time from the GPS satellite to the terminal device, the propagation time being obtained by analyzing the signal received from the GPS satellite. The state in which an original information signal is detected according to the matching of the timing to resultantly reproduce a signal having large amplitude is called a synchronized state or an acquired state.

Particularly, in the CDMA method, a digital information signal of about 10 kiloherz (kHz) is modulated into a baseband signal using a pseudo random signal of about 1 megaherz (MHz) having a predetermined length. The baseband signal is modulated into a radio signal of about one gigaherz (GHz) for transmission. On the other hand, the radio signal is heterodyned to be detected on the receiver side. The detected signal is demodulated into a baseband signal having a frequency for digital processing. Thereafter, the signal is demodulated using the same pseudo-random signal. A binary multiplication between the original digital signal and the digital pseudo-random signal is called “spectrum spread demodulation”. An operation in which the spread spectrum signal is multiplied by the same digital pseudo-random signal to extract the original signal is called “despreading”. Since the spread spectrum signal is a random signal of about one megaherz, only a signal having an amplitude equal to or less than predetermined amplitude is detected. In the despreading, when the spread spectrum signal is multiplied by a pseudo-random signal used to spread the spectrum, a random signal similar to the spread spectrum signal is output. When the timing matches that of the spreading phase, the original information signal is detected to reproduce a signal having large amplitude. This state is called a synchronized state or a synchronization acquired state in the CDMA method.

To establish synchronization with the GPS signal from the GPS satellite 104, the portable telephone 102 or the reference GPS receiver server 103 outputs a pseudo-random signal used in the GPS signal while shifting its timing. The telephone 102 or the server 103 detects the signal being outputted when the signal matches the GPS signal. Thereafter, the telephone 102 or the server 103 controls operation to keep the state. A planned orbit and a pseudo-random signal of each GPS are open to the public. However, since the GPS signal is concealed in noise, a period of time equal to or more than 30 minutes is required if a range of reference time is not beforehand predicted to establish synchronization. The basic operation of position measurement in the portable telephone 102 has been described. Next, a general operation of the position measurement will be described.

On receiving an instruction to start position measurement, the telephone 102 establishes a path to communicate with the server 103 as a reference GPS receiver and issues a request to start position measurement. The server 103 continuously receives the GPS signal 105 from each GPS satellite 104 and generates, according to synchronization timing of the GPS signal 105, GPS assist information 108 synchronized with a signal transmitted from the base station 107 via an exchange 106. The server 103 then sends the assist information 108 to the telephone 102. The information 108 is information regarding signals of GPS satellites 104 from which signals can be received. The information includes timing information for the telephone 102 to establish synchronization and information of an elevation angle (elevation information) relative to the surface of the earth of each GPS satellite 104 viewed from the server 103. The telephone 102 establishes synchronization with each GPS signal using the received assist information 108 to detect the difference of time between the synchronization timing and that of the base station 107 and reports the difference of time via the base station 107 to the server 103. The period of time is called “pseudo-distance”.

Next, description will be given of a method of detecting synchronization between the telephone 102, each GPS satellite 104, and the base station 107 and a method of detecting the difference of time between the synchronization timing. The method to acquire synchronization between the telephone 102 and the base station 107, that between the telephone 102 and the GPS satellite 104, and that between the server 103 and the GPS satellite 104 are fundamentally equal to each other. However, the contents of signals and the codes of the pseudo-random signals vary depending on the cases. The base station 107 and the server 103 operate according to signals sent from GPS satellites 104 respectively nearest thereto. The base station 107 transmits, according to reference timing obtained from the signal from the GPS satellite 104, a pilot signal spread using a predetermined pseudo-random signal to the telephone 102. The telephone 102 detects a peak of the received signal and establishes synchronization as described above.

Having received the pilot signal, the telephone 102 transmits information regarding the telephone 102 to the base station 107 at timing synchronized with the received pilot signal. The base station 107 obtains difference between the pseudo-pilot signal output timing shifted to synchronize with the signal sent from the telephone 102 and the output timing of the pilot signal sent from the base station 107 and multiplies the difference by the velocity of electric waves, namely, the velocity of light to predict distance between the base station 107 and the telephone 102. To receive the GPS signal from the GPS satellite 104, the telephone 102 establishes synchronization with the base station 107 and then interrupts communication therewith and generates internal reference timing according to an oscillator in the telephone 102. Using the internal reference timing as reference timing, the telephone 102 shifts the pseudo-random signal for the despreading to resultantly obtain the signal peak in the method described above. According to difference between the pseudo-random signal output timing at detection of the signal peak and the internal reference timing, the telephone 102 obtains the difference of time. The GPS signal synchronizer 203 includes a predetermined number of time difference detector sections 204 to concurrently conduct measurements for the respective GPS satellites 104.

Therefore, it is possible in this case to reduce the error in the result of time difference measurement of each GPS satellite 104 when compared with a case in which the time difference is repeatedly measured for each GPS satellite 104. When the time difference is simultaneously measured for four or more GPS satellites 104, the common error (for example, difference with respect to the internal reference timing of the telephone 102) contained in the measured value of time difference of each GPS satellite 104 can be removed by calculation. The telephone 102 ordinarily completes the time difference measurement of the GPS signal acquisition of each GPS satellite 104 in several seconds. Thereafter, the telephone 102 again establishes synchronization with the base station 107 and transmits the acquisition result to the server 103.

The period of time between the peak timing of the signal detected for each GPS satellite 104 and the reference timing of the base station 107 is called “acquisition result”. The server 103 keeps propagation delay information between the base station 107 and the portable telephone 102 to obtain the difference relative to the GPS pseudo-distance. By adding the difference to the propagation time already detected between the GPS satellite 104 and the reference GPS receiver of the base station 107, the propagation time between the telephone 102 and the GPS satellite 104 can be obtained. The basic concept of the GPS position measuring method has been described.

In the first embodiment of the present invention, the telephone 102 evaluates, using the basic concept and information regarding each GPS satellite 104, reliability of the signal from the GPS satellite. The information regarding each GPS satellite 104 includes, for example, information of elevation and information of field intensity. When it is determined that the reliability is less than a predetermined level, the telephone 102 reports the acquisition result via a communication line to the server 103 using the information regarding the GPS satellite. That is, the controller 216 of the telephone 102 controls operation according to the acquisition result of the GPS satellite signal received by the GPS signal receiver 202, namely, the reliability of the signal to send a request report to the server 103 to remove information of GPS satellites transmitting less reliable signals. Although the number of GPS satellites for which the server 103 supplies GPS assist information to the telephone 102 is unequal to that of acquisition results of GPS satellites 104 received from the telephone 102, the server 103 executes processing regardless of the number of GPS assist information. Using the acquisition results from the telephone 102, namely, acquisition results with high reliability, the server 103 calculates the position of the telephone 102 by executing ordinary processing and reports the resultant position via a communication line to the telephone 102. Therefor, the telephone 102 can provide the user with a highly reliable service using the position.

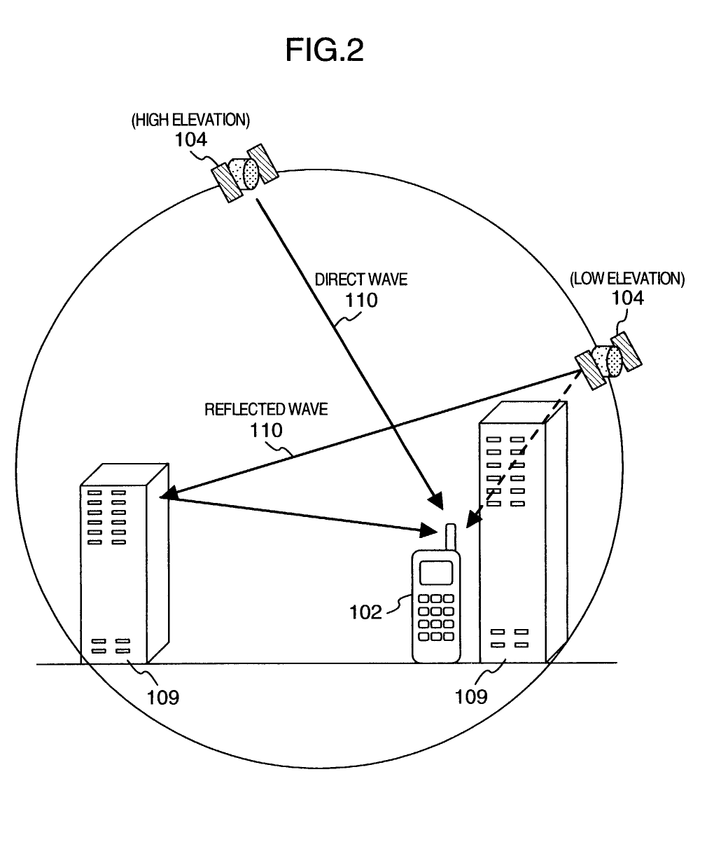

Description will now be given of a second embodiment of the present invention by referring to FIG. 2. In the embodiment, when the portable telephone 102 acquires signals from N GPS satellites (N is an integer equal to or more than one), at most N acquisition results are selected from acquisition results of signals from N GPS satellites according to elevation information obtained from the GPS assist information as position measurement assist information. The selected acquisition results are then notified to the server. At a position in the neighborhood of high-rise buildings 109, there appears a state of a multipath 110 in which a direct wave and a reflected wave thereof from a wall surface of a building exist. Even in the neighborhood of high-rise buildings 109, if the target GPS satellite has a high elevation angle, it is highly possible to receive a direct wave. Therefore, in the second embodiment, the GPS assist information includes elevation information of the target GPS satellite and the portable telephone 102 includes algorithm in which GPS information associated with high elevation is arbitrarily selected from the GPS acquisition results obtained by the telephone 102 and is then reported to the server.

The telephone 102 cannot determine by itself whether the received signal is a direct wave or a reflected wave. However, if the signal is received from a GPS satellite 104 with high elevation, it is highly possible that the signal is a direct wave. Even if the signal is a reflected wave, when the signal is received from a GPS satellite 104 with high elevation, the difference in propagation distance of the electric wave is small between the reflected wave and the direct wave. Therefore, a position resultant from the calculation includes a small error. To take advantage of this event, a predetermined number of GPS information associated with high elevation is beforehand selected from the GPS acquisition results obtained by the telephone 102 and is reported to the server 103. This reduces the factor of the reflected wave deteriorating the results of position calculation. When the acquisition results have sufficiently high precision, four GPS satellite acquisition results suffice for the processing. However, since each acquisition result includes an error, four or more GPS satellite acquisition results are desired if the measurement results are reliable.

At present, the portable telephone 102 can observe at least six GPS satellites under a general condition. When it is desired to have four or more GPS satellites with high elevation, it is expectable that the elevation angle ranges from about 30° to about 40°. It is therefore difficult at present to obtain four or more acquisition results with high reliability in a district of high-rise buildings. However, in a district of low buildings or the like, it is expectable to have GPS satellites from which four or more direct waves can be possibly received. Therefore, when acquisition results from the GPS satellites with elevation exceeding predetermined elevation are sent to the server 103, the server 103 can calculate a position of the telephone 102 with high precision.

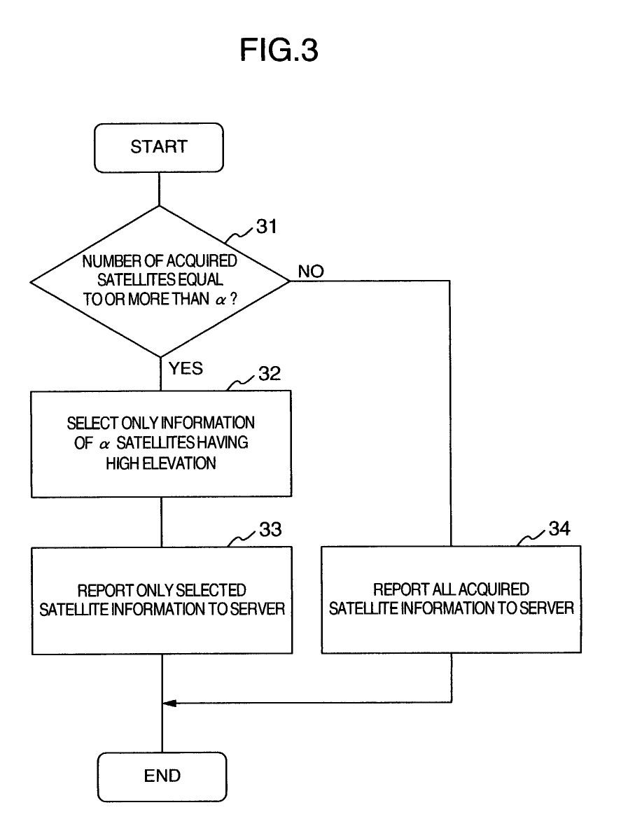

Description will be given of a processing procedure of the second embodiment by referring to the flowchart of FIG. 3. In step 31, it is determined whether or not the number of GPS satellites 104 acquired by the telephone 102 is sufficient to detect precision of position. Assume that α GPS satellites (a is a positive integer) are required to obtain the precision of position. If sufficient, namely, if N is equal to or more than α and when N GPS satellites are acquired, only α GPS satellites with high elevation notified by the GPS assist information 108 are selected from the acquired N GPS satellites in step 32. In step 33, only the acquisition results of the selected GPS satellites 104 are reported to the server 103. This can reduce the deterioration in the precision of the detected position by the reflected wave. If the number of the acquired GPS satellites 104 is insufficient, namely, if N is less than α, the acquisition results of the acquired GPS satellites 104 are reported to the server 103 in step 34. As a result, although the detected position has low precision, even if the sufficient number of GPS satellites 104 cannot be acquired, the position can be detected.

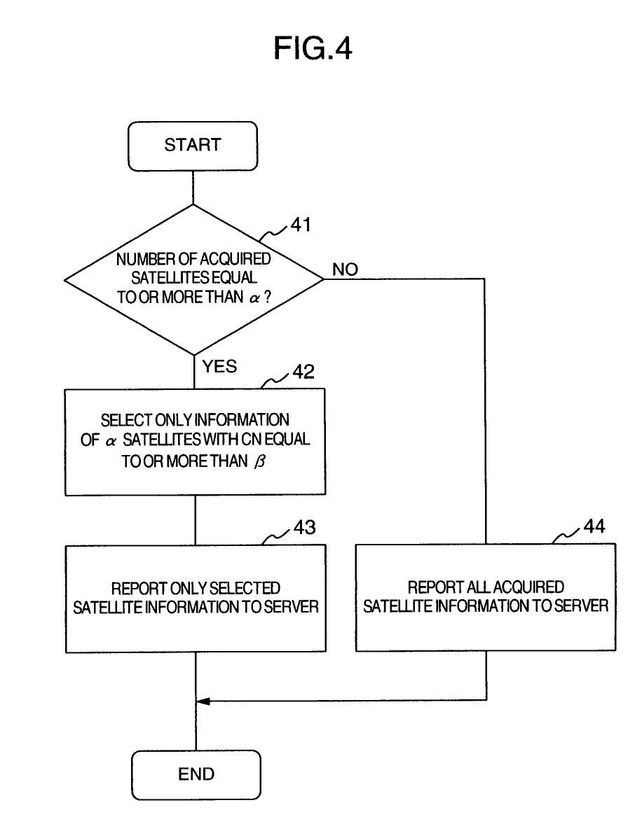

Description will next be given of a third embodiment of the present invention by referring to the flowchart of FIG. 4. In the embodiment, when the telephone 102 acquires signals from N GPS satellites (N is an integer equal to or more than one), N or less acquisition results are selected according to field intensity of the signals from the acquired GPS satellites and are then sent to the server. In the embodiment, according to the field intensity of the signals from the GPS satellites acquired by the telephone 102, the GPS satellites 104 acquired by the telephone 102 are selected in a descending order of field intensity and are reported to the server. When the field intensity is low, uncertainty is increased. Therefore, by selecting the GPS satellites in the ascending order of field intensity, the error in the detection precision caused by GPS information can be reduced. Since the position can be correctly calculated using four or more GPS information, it is determined in step 41 whether or not the number of GPS satellites 104 acquired by the telephone 102 is enough to detect the position. If N is equal to or more than a, a required number of GPS satellites, namely, a GPS satellites are selected in a descending order of field intensity from GPS satellites with field intensity CN equal to or more than a preset value β and are then reported to the server 103.

Since the field intensity CN received by the telephone 102 is influenced by a direction of an antenna disposed in the telephone 102, it is necessary that the antenna is in a posture to sense with high sensitivity an electric wave from a satellite having high elevation. By arranging a configuration to judge the posture, the operation can be more efficiently conducted. This is required to determine a priority level of the field intensity. In the system, the posture judge section includes a combination of a terrestrial or earth magnetism sensor to sense the direction of the antenna and a tilt sensor to sense a tilt of the antenna. Depending on characteristics of the antenna, only the terrestrial magnetism sensor is used to sense the direction.

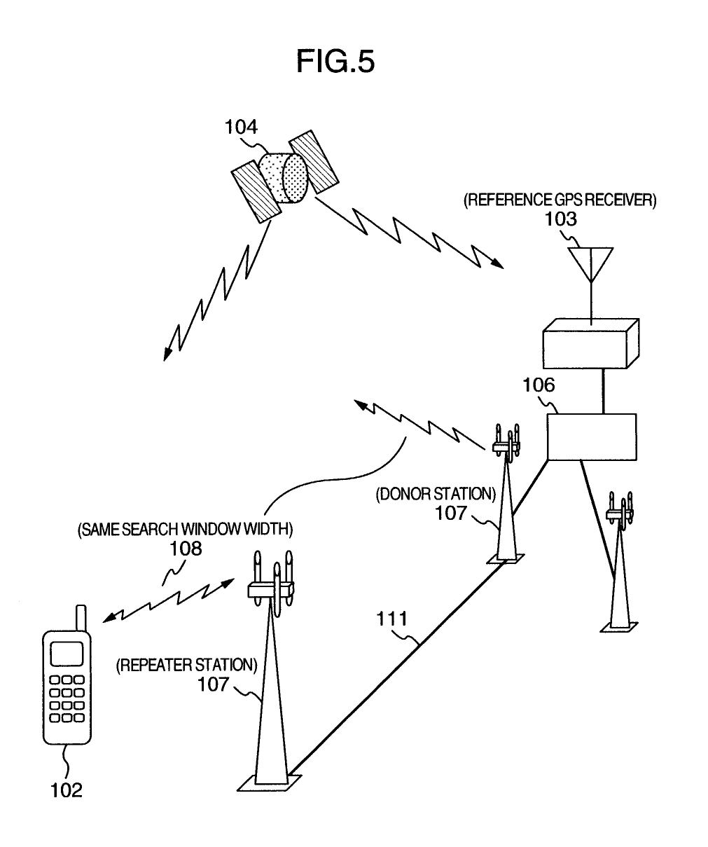

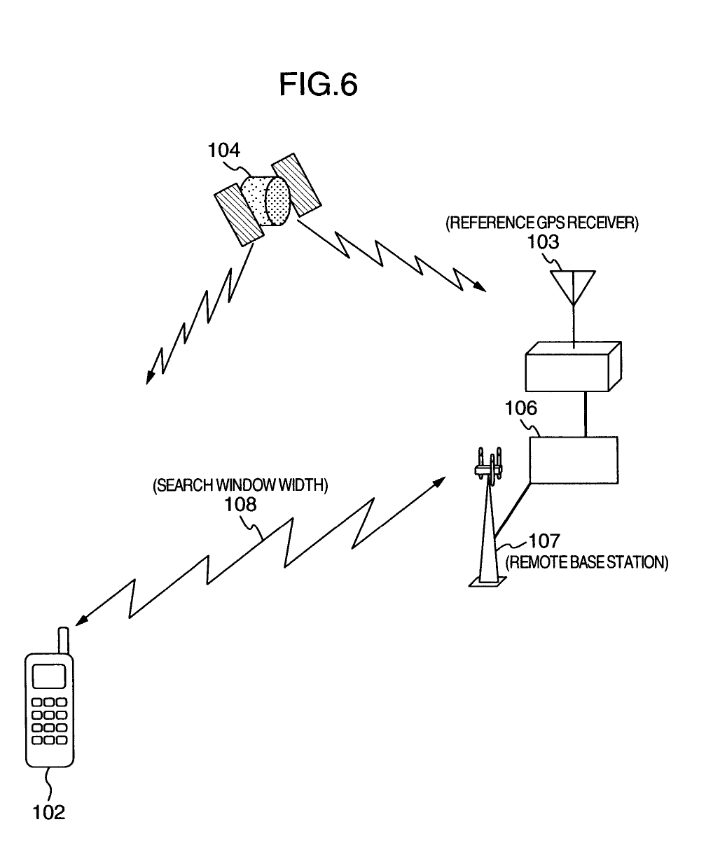

Description will now be given of a fourth embodiment of the present invention by referring to the flowchart of FIGS. 5 to 10. In the embodiment, when the telephone 102 acquires signals from N GPS satellites (N is an integer equal to or more than one), width or timing of a search window to acquire the signal from the GPS satellite is changed according to elevation information obtained from the position measurement assist information. This embodiment gives consideration to signal propagation delay appearing when a donor station is connected via an optical cable 111 to a repeater station as shown in FIG. 5 as well as to influence of a remote base station disposed as shown in FIG. 6.

The GPS assist information includes errors caused by the influence of the optical cable 111 and the remote base station 107. This leads to a problem that the inherently observable GPS satellite 104 cannot be observed. This problem is solved as follows. For a GPS satellite 104 having high elevation, it is less likely that delay occurs due to a reflected wave. Therefore, consideration is given only to the delay of the optical cable 111 and that of the remote base station 107. For a GPS satellite 104 having low elevation, it is assumed that delay occurs due to a reflected wave and the delay of the optical cable 111 and that of the remote base station 107 are removed. This increases possibility to acquire signals from GPS satellites 104.

That is, according to the elevation information obtained from the GPS assist information 108, the telephone 102 sets the width of the search window to acquire the GPS signal indicated by the assist information 108 to a values in association with the delay caused by the optical cable 111 and the remote base station 107. If the elevation obtained from the assist information 108 is more than a predetermined value and hence the telephone 102 cannot acquire the GPS signal, the telephone sets the search window width to acquire the GPS signal to a value in association with the delay caused by the optical cable 111 and the remote base station 107.

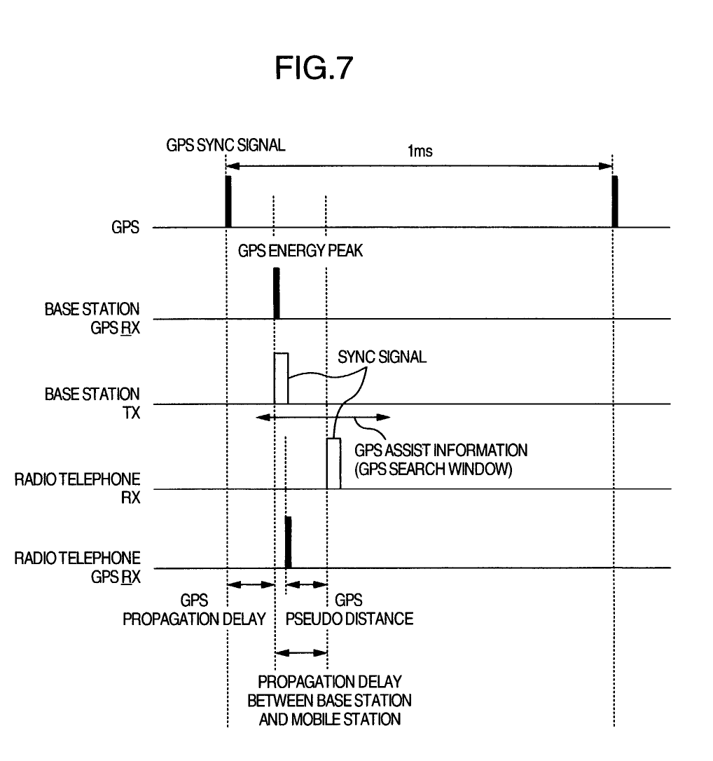

The fourth embodiment of the present invention will be described in more detail by referring to the timing charts shown in FIGS. 7 to 9. FIG. 7 is a timing chart example of GPS acquisition of the telephone 102. In the global positioning system, a synchronizing (sync) signal is generated at an interval of one millisecond (ms). The GPS receiver of the base station 107 receives a GPS signal 105 to detect a GPS energy peak. Difference between the sync signal and the GPS energy peak is the delay of the GPS signal. The GPS satellite 104 refers to an atomic clock to keep a high-precision reference time. Using the signal received from each GPS satellite, the server 103 knows distance between the server 103 and the GPS satellite. According to the distance, the server calculates a period of time T1 (GPS propagation delay) required for the signal to propagate from the GPS satellite to a position near the server 103. At timing synchronized with the detection timing, the base station 107 transmits the GPS assist information 108 from its transmitter to the telephone 102. Since the base station and the telephone 102 are operating in a synchronous way, a period of time T2 (propagation delay between base station and mobile station) required for an electric wave to propagate from the base station 107 to the telephone 102 can be obtained using difference between the signal from the base station 107 and the signal from the telephone 102. Therefore, the synchronization timing of the GPS assist information is received by the telephone 102 with a delay of T2 for the signal propagation from the telephone 107 and the base station 107.

When the base station 107 is less apart from the portable telephone 102, it is predicted that the telephone 102 receives the GPS signal at a point of time less differing from when the GPS receiver 103 of the base station 107 receives the GPS signal. When consideration is not given to delay due to other factors, the GPS assist information 108 includes information of a search window centered on a point of time advanced in time by T2 relative to the sync signal received from the telephone 102. The telephone 102 received by its receiver the GPS assist information 108 at timing associated with the propagation delay from the base station 107. The GPS receiver of the telephone 102 searches the obtained search window range for the GPS sync signal. Resultantly, the receiver can ordinarily acquire the sync signal in a short period of time. The server.103 calculates the position using the difference (GPS pseudo distance) between the GPS energy peak and the synchronization timing acquired by the telephone 102.

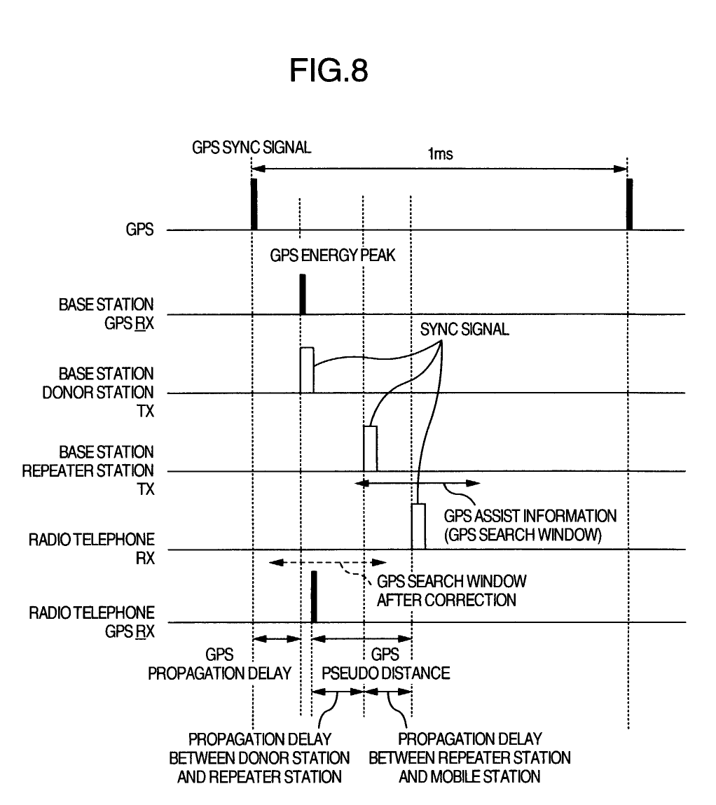

FIG. 8 shows a timing chart example when the base station 107 is an optical repeater station. FIG. 8 differs from FIG. 7 in that the timing for the base station 107 to transmit the GPS assist information is also associated with the propagation delay of the optical cable connecting the repeater station to the donor station including the GPS receiver 103. The search window indicated by the assist information 108 is not associated with the propagation delay of the optical cable. Therefore, when the delay of the optical cable is a long period of time, even if the telephone 102 makes a search for a sync signal of the GPS signal according to the assist information 108, the telephone 102 cannot acquire the sync signal.

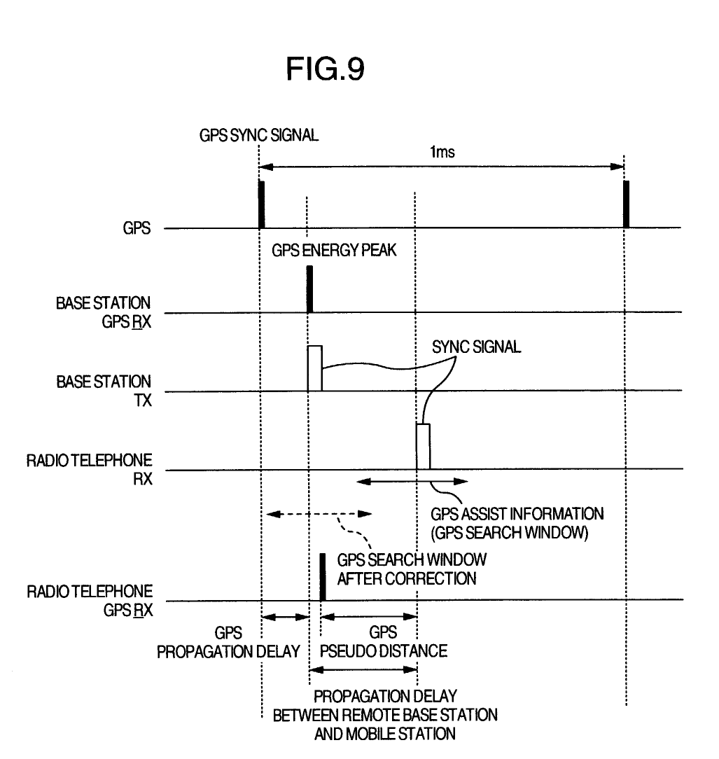

FIG. 9 shows a timing chart when the base station 107 is a remote base station. In this case, propagation delay of the remote base station and propagation delay of the portable telephone 102 take place. The search window width of the GPS assist information 108 is not associated with the propagation delay of the remote base station. Depending on cases, it is therefore impossible to make a search for the GPS signal at timing at which the GPS signal is inherently observed, and hence the GPS energy peak cannot be observed. Transmission power of the telephone 102 to transmit a signal to the base station 107 is increased in this case. Therefore, when the GPS signal cannot be acquired because the transmission power exceeds a predetermined value, the search window is set in association with the propagation delay of the remote base station to try the signal acquisition again. This increases possibility of successfully acquiring the signal.

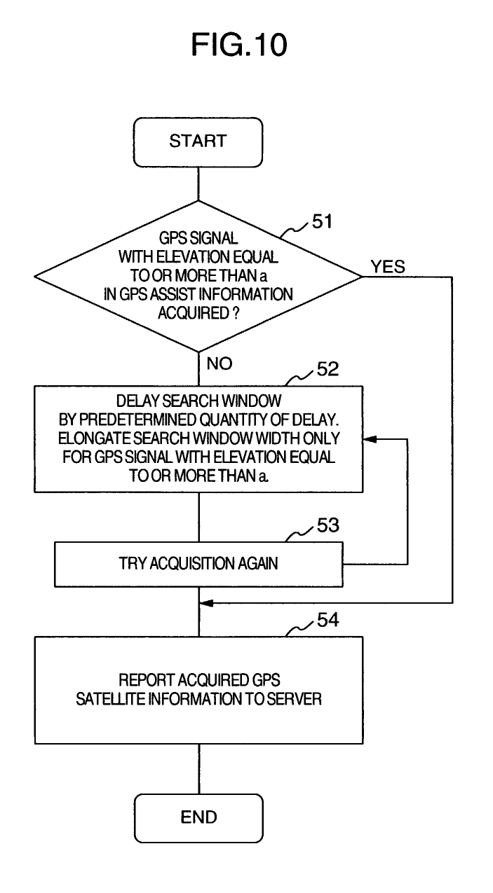

The fourth embodiment of the present invention will be described by referring to the flowchart of FIG. 10. In step 51, a check is made to determine whether or not a GPS signal with an elevation angle equal to or more than a is acquired. If such a signal is not acquired, the search window is delayed by a predetermined quantity of delay in step 52. If necessary, the search window width is elongated only for the GPS signal with an elevation signal equal to or more than a. In step 53, the signal acquisition is tried again. If the signal cannot be acquired, control returns to step 52. By changing the quantity of delay, the acquisition of the GPS signal is tried again. The acquisition result obtained in step 54 is reported to the server 103. This solves the problem of the delay associated with the optical cable and the remote base station.

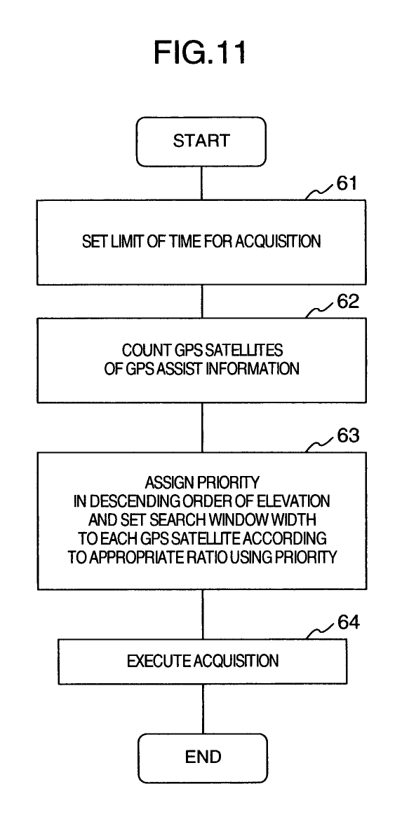

The fifth embodiment of the present invention will be described by referring to the flowchart of FIG. 11. This embodiment includes a setting section to set a measuring period of time required to acquire a signal from a GPS satellite. According to the measuring time set by the setting section, the algorithm regarding the acquisition of the GPS satellite signal is changed. By elongating the search window width, it is predicted that the acquisition time is elongated. However, there possibly exists a case in which it is desired that the position measurement is completed within a predetermined period of time although precision of the measurement is lowered. In such a case, the overall acquisition time can be limited by arbitrarily setting a period of time required for the acquisition. By setting the acquisition period, usability is improved for the users.

In step 61, the position measuring time is arbitrarily set for the telephone to acquire the GPS signal. In step 62, the number of GPS signals is obtained from the GPS assist information. According to elevation of each GPS satellite 104 and information sent from the telephone 102 to the base station 107, an appropriate one of the position measuring calculations or methods is selected. In step 63, a priority level is assigned to each satellites 104 in a descending order of elevation, a search window width is set to a signal from each GPS satellite according to an appropriate ratio associated with the priority level order. In step 64, the GPS satellite signal acquisition is executed.

In the fifth embodiment, the measuring period of time including a period of time for the telephone 102 to acquire a GPS signal is set. According to the measuring time, a priority level is assigned to each GPS satellite in a descending order of elevation of the satellite, and a search window width is set to a signal of a GPS satellite according to a ratio set in a descending order of priority. A GPS satellite with highest elevation is acquired. Synchronization timing to acquire the GPS satellite is as reference timing. Thereafter, difference between the reference timing and synchronization timing obtained from the GPS assist information is used to acquire each GPS satellite in a sequential way. It is therefore possible to reduce the acquisition time. The period of time required to acquire all GPS satellites can be resultantly limited.

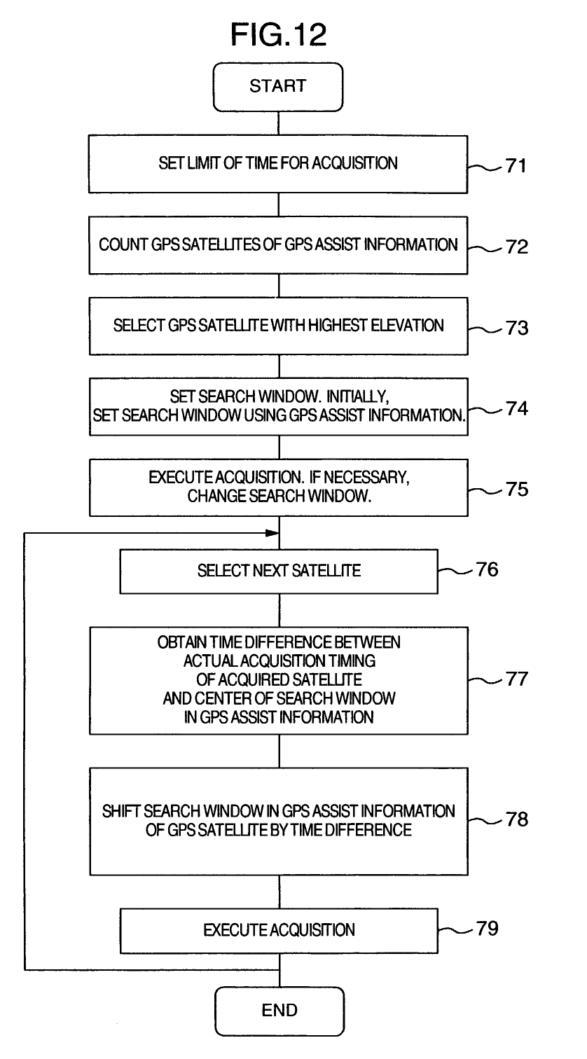

Referring now to FIG. 12, description will be given of the sixth embodiment capable of generally increasing the GPS signal acquisition speed. In this embodiment, the change of the search window width according to a time set by the setting section is conducted by changing an algorithm.

The server 103 beforehand stores therein relative time difference between acquisition timing of respective GPS satellites 104, the acquisition timing being contained in the GPS assist information. Therefore, if a signal of a first GPS satellite is acquired, acquisition timing of another GPS satellite can be predicted by adding the relative time difference with respect to the first GPS satellite to the acquisition timing of the first GPS satellite. Therefore, the system first acquires a signal of a first GPS satellite of which the GPS assist information can be easily acquired. Thereafter, a signal of each remaining GPS satellite is acquired on the basis of the acquisition of the first GPS satellite. In general, it is considered that a GPS satellite with higher elevation can be more easily acquired. However, depending on an environment of the portable telephone 102, a GPS satellite with lower elevation can be more easily acquired.

Steps 71 and 72 are similar to steps 61 and 62 of the fifth embodiment. In step 73, a GPS satellite with highest elevation is selected. In step 74, GPS assist information is obtained from the base station 107. A GPS signal is acquired from the GPS satellite. After the first GPS signal is acquired, a next GPS satellite is selected in step 76. In step 77, timing difference in synchronization timing is obtained between the preceding GPS satellite and the pertinent GPS satellite using the GPS assist information. In step 78, the search window is set by shifting the window by the synchronization timing difference relative to the synchronization timing of the acquired GPS signal. In step 79, a signal is acquired from the GPS satellite. The operation is repeatedly conducted as many times as required. These steps can solve the problem of elongation of the acquisition time due to delay caused by the optical cable and the remote base station.

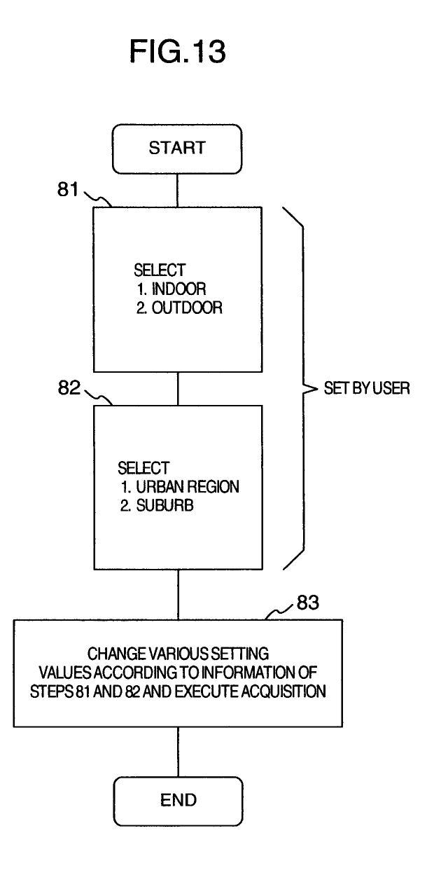

Referring now to the flowchart of FIG. 13, description will be given of the seventh embodiment of the present invention. This embodiment includes an environment setting section to beforehand setting information regarding an environment of a position of the portable telephone 102. According to the environment information supplied by the environment setting section, an algorithm is set for the position measurement. In the embodiment, the user beforehand selects information of the environment of the position to be measured: “indoor” or “outdoor” and “urban region” or “suburb”. According to the information of the environment, a position measuring algorithm is selected to increase precision of the position detection.

In the seventh embodiment, the telephone 102 displays, on the information output section 214 such as a display, selection items indicating information of the environment of the position to be measured. The user selects one of the selection items. The embodiment issues inquiries in two stages. In the first stage, the telephone 102 displays selection items “indoor” and “outdoor” as the information of the environment. In the second stage, the telephone 102 displays selection items “urban region” and “suburb” as the information of the environment. The number and kinds of selection items may be appropriately changed according to necessity. The user of the portable telephone 102 watches a display screen of the display. In step 81, the user selects the environment information, i.e., “indoor” or “outdoor” to obtain information of the position. In step 82, the user selects the information “urban region” or “suburb”. By selecting a simple combination of “indoor or outdoor” and “urban region or suburb” in steps 81 and 82, conditions can be set as follows.

When the telephone 102 is at a position of (1) “outdoor and suburb”, signals of all GPS satellites are acquired in a descending order of elevation of the satellites. When the telephone is at a position of (2) “outdoor and urban region”, signals of four GPS satellites are acquired in a descending order of elevation of the satellites. When the telephone is at a position of (3) “indoor and suburb”, signals of all GPS satellites having relatively low elevation are acquired. When the telephone is at a position of (4) “indoor and urban region”, signals of all GPS satellites having relatively low elevation are acquired. Step 83 specifically conducts operation as follows. Using above conditions, step 83 changes various setting values and executes acquisition of GPS satellites suitable for the position to be measured.

For the combinations (3) and (4) of selection items, the required number of GPS signals cannot be acquired depending on cases. Having received a report of such impossible acquisition from the telephone 102, the server 103 connected to the base station 107 employs a method in which signals of the GPS receiver are used for the signals insufficient in the above cases. In this embodiment, the user beforehand supplies environment information of the position measurement. In step 83, a method of position measurement is selected according to the environment information and hence the position can be detected with high precision.

The hardware configuration of FIG. 14 is commonly applied to the first to seventh embodiments.

According to the embodiments described above, an algorithm is provided for the portable telephone including a GPS receiver to reduce or to remove by itself the factor of deterioration in precision of the position detection. Therefore, the position information can be obtained with high precision.

According to the present invention, there is provided a portable terminal device capable of correctly detecting a position thereof by preventing occurrence of an error due to an environmental state or condition of the terminal device.

Many different embodiments of the present invention may be constructed without departing from the spirit and scope of the invention. It should be understood that the present invention is not limited to the specific embodiments described in this specification. To the contrary, the present invention is intended to cover various modifications and equivalent arrangements included within the spirit and scope of the claims.

What is claimed is:

1. A portable terminal device, comprising:
a first receiving section which receives elevation information regarding an elevation angle of a satellite viewed from a base station;
a second receiving section capable of receiving signals sent from a plurality of satellites;
a selecting section which selects, when the second receiving section receives signals sent from at least N satellites (N is an integer equal to or more than one), M signals (M is an integer equal to or more than one) from the N or more signals, the M signals having high values of the elevation information;
a first transmitting section which transmits the signals selected by the selecting section to the base station; and
a second transmitting section which transmits, when the second receiving section receives signals sent from at most (N−1) satellites, the signals received by the second receiving section to the base station.

2. A portable terminal device according to claim 1, wherein when the second receiving section receives signals sent from at least N satellites, width or timing of a search window to receive signals sent from the satellites is changed according to the elevation information.

3. A portable terminal device according to claim 1, further comprising a setting section which sets a period of time required for the second receiving section to acquire a signal sent from a satellite, wherein
width of a search window is changed according to the period of time set by the setting section.

4. A portable terminal device according to claim 1, further comprising an input section which inputs information regarding a state of an environment of the portable terminal device.

5. A portable terminal device, comprising:
a receiving section capable of receiving signals sent from a plurality of satellites;
a selecting section which selects, when the receiving section receives signals sent from at least N satellites (N is an integer equal to or more than one), M signals (M is an integer equal to or more than one) from the N or more signals according to field intensity of the N or more signals;
a first transmitting section which transmits the signals selected by the selecting section to the base station; and
a second transmitting section which transmits, when the receiving section receives signals sent from at most (N−1) satellites, the signals received by the receiving section to the base station.

6. A portable terminal device according to claim 5, wherein the receiving section comprises:
an antenna; and
a detecting section which detects a direction or a tilt of the antenna.
